(19) United States
(12) Patent Application Publication
(10) Pub. No.: US 2008/0271142 A1
(43) Pub. Date: Oct. 30, 2008

(54) PROTECTION AGAINST BUFFER OVERFLOW ATTACKS

(75) Inventors: Piotr Michal Murawski, Biot (FR); Mehdi-Laurent Akkar, Juan Les Pins (FR); Aymeric Stephane Vial, Juan Les Pins (FR)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/773,194

(22) Filed: Jul. 3, 2007

(30) Foreign Application Priority Data
Apr. 30, 2007 (EP) 07290535.9

(51) Int. Cl. G06F 17/00

(52) U.S. Cl. 726/22

(57) ABSTRACT

A system including storage comprising software code and a plurality of data structures. The system also includes processing logic coupled to the storage and adapted to execute the software code. If the processing logic executes a function call instruction, the processing logic stores copies of software code return information to a first data structure location and to a second data structure location. If, after executing a function associated with the function call instruction, the processing logic determines that data from the first and second data structure locations do not match, the processing logic initiates a security measure. The data is associated with the copies.

### CROSS-REFERENCE TO RELATED APPLICATIONS

This application claims priority to EPO Patent Application No. 07290535.9, filed on Apr. 30, 2007, incorporated herein by reference.

### BACKGROUND

For security reasons, at least some mobile device processors provide two levels of operating privilege: a first level of privilege for user programs; and a higher level of privilege for use by the operating system. The higher level of privilege may or may not provide adequate security, however, for m-commerce and e-commerce, given that this higher level relies on proper operation of operating systems with highly publicized vulnerabilities. In order to address security concerns, some mobile equipment manufacturers implement yet another third level of privilege, or secure mode, that places less reliance on corruptible operating system programs, and more reliance on hardware-based monitoring and control of the secure mode. An example of one such system may be found in U.S. Patent Publication No. 2003/0140245, entitled “Secure Mode for Processors Supporting MMU and Interrupts.”

Despite these security measures, systems remain vulnerable to various software attacks. For example, when executing software code, a processing logic may execute a call to service a function. Because servicing the function involves temporarily halting execution of the software code, the processing logic may store various types of information pertaining to the software code before executing the function. The processing logic stores this information associated with the software code in order to “save its place” so that, when it is finished executing the function, the processing logic may resume executing the software code where it left off. This information that is stored is referred to as “context information.” Included in the context information is a return address which indicates where in the software code the processing logic should resume execution after the function has been serviced. The return address may be stored, for example, on a program stack.

A buffer overflow attack is an attack in which a malicious entity, such as a hacker, overwrites the return address on the program stack with a different address. Instead of pointing to the software code, this different address points to malicious code stored on the system. Thus, when the processing logic finishes executing the function and reads the program stack to determine the return address, the processing logic begins executing malicious code instead of the software code. In this way, the integrity of the system's security is compromised.

### SUMMARY

Accordingly, there are disclosed herein techniques by which a system is protected from malicious attacks such as those described above (e.g., buffer overflow attacks). An illustrative embodiment includes a system including storage comprising software code and a plurality of data structures. The system also includes processing logic coupled to the storage and adapted to execute the software code. If the processing logic executes a function call instruction, the processing logic stores copies of software code return information to a first data structure location and to a second data structure location. If, after executing a function associated with the function call instruction, the processing logic determines that data from the first and second data structure locations do not match, the processing logic initiates a security measure. The data is associated with the copies.

Another illustrative embodiment includes a system comprising processing logic adapted to execute software code. The system also comprises a first data structure location and a second data structure location. Upon returning from a function call to the software code, the processing logic asserts a security signal if values retrieved from the first and second data structure locations do not match. The data structure locations are associated with a return address of the software code.

Yet another illustrative embodiment includes a method. The method comprises storing copies of a return address associated with software code in first and data structures if, while executing the software code, a function call instruction is executed. The method also comprises executing a function associated with the function call instruction and obtaining a first datum from the first data structure and a second datum from the second data structure. The first and second data are associated with the copies of the return address. The method further comprises, if the first and second data do not match, generating a security violation signal.

Yet another illustrative embodiment includes a system, comprising means for pushing copies of a return address associated with software code onto first and second stacks, where the return address is associated with a function call instruction in the software code. The system also includes means for initiating security measures. After executing a function associated with the function call instruction, the means for pushing determines whether a first datum from the first stack matches a second datum from the second stack, where the first and second data are associated with the copies. If the first and second data are mismatched, the means for pushing alerts the means for initiating security measures.

### BRIEF DESCRIPTION OF THE DRAWINGS

For a detailed description of exemplary embodiments of the invention, reference will now be made to the accompanying drawings in which:

FIG. 1 shows an illustrative mobile communication device within which the techniques disclosed herein may be implemented, in accordance with embodiments of the invention;

FIG. 2 shows an illustrative block diagram of a system in accordance with preferred embodiments of the invention;

FIG. 3 shows a conceptual illustration of the techniques disclosed herein, in accordance with embodiments of the invention; and

FIG. 4 shows a flow diagram of a method implemented in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein are various embodiments of a technique which protects a system against buffer overflow attacks. The technique disclosed herein causes a processing logic to store multiple copies of a return address in different stacks before executing a function. After executing the function, the processing logic compares the multiple copies of the return address by popping them off of the different stacks. If the copies do not match each other, it is likely that a buffer overflow attack has occurred and appropriate security measures are taken. If the copies match each other, the processing logic uses the return address indicated by the copies to resume execution of software code. Storing multiple copies of the return address in various stacks thwarts buffer overflow attack attempts because buffer overflow attacks are able to target only a single stack. In this way, integrity of the system security is maintained.

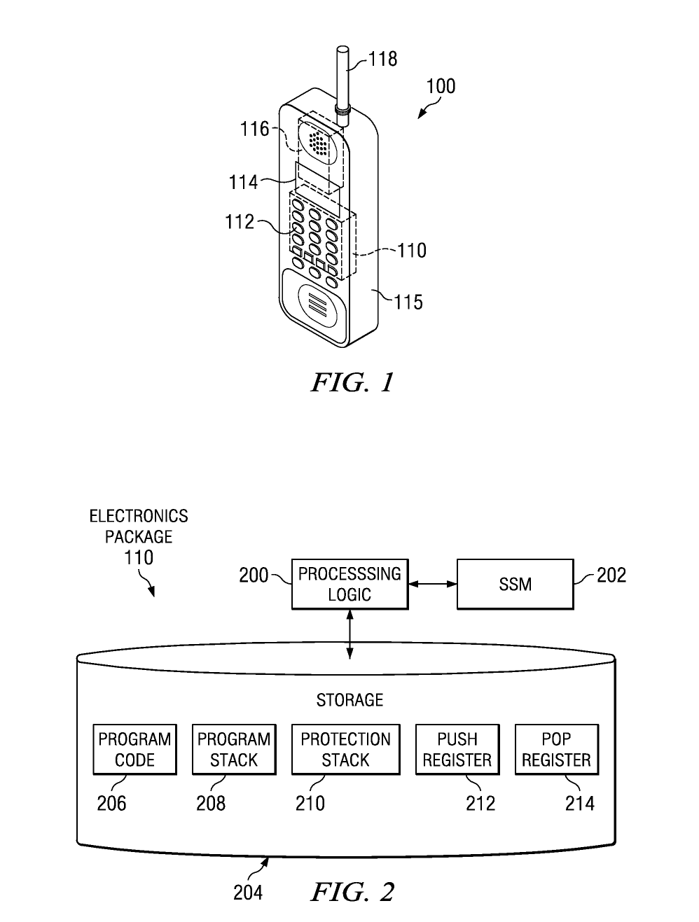

FIG. 1 shows an illustrative mobile communication device 100 (e.g., a mobile phone) implementing the security technique in accordance with embodiments of the invention. The device 100 comprises a battery-operated device which includes an integrated keypad 112 and display 114. The device 100 also includes an electronics package 110 coupled to the keypad 112, display 114, and radio frequency (“RF”) circuitry 116. The electronics package 110 contains various electronic components used by the device 100, including processing logic, storage logic, etc. The RF circuitry 116 may couple to an antenna 118 by which data transmissions are sent and received. Although the mobile communication device 100 is represented as a mobile phone in FIG. 1, the scope of disclosure is not limited to mobile phones and also may include personal digital assistants (e.g., BLACKBERRY® or PALM® devices), multi-purpose audio devices (e.g., APPLE® iPHONE® devices), portable computers or any other mobile or non-mobile electronic device. In at least some embodiments, devices other than mobile communication devices are used.

FIG. 2 shows an illustrative block diagram of at least some of the contents of the electronics package 110. The package 110 comprises a processing logic 200, a secure state machine (SSM) 202 coupled to the processing logic 200, and a storage 204 also coupled to the processing logic 200. In turn, the storage 204 comprises program code (e.g., software code) 206, a program stack 208, a protection stack 210, a push register 212 and a pop register 214. The storage 204 may comprise a processor (computer)-readable medium such as random access memory (RAM), volatile storage such as read-only memory (ROM), a hard drive, flash memory, etc. or combinations thereof. Although storage 204 is represented in FIG. 2 as being a single storage unit, in some embodiments, the storage 204 comprises a plurality of discrete storage units. Each of the stacks 208 and 210 preferably comprises a last-in, first-out (LIFO) data structure, although other types of stacks also are included within the scope of this disclosure.

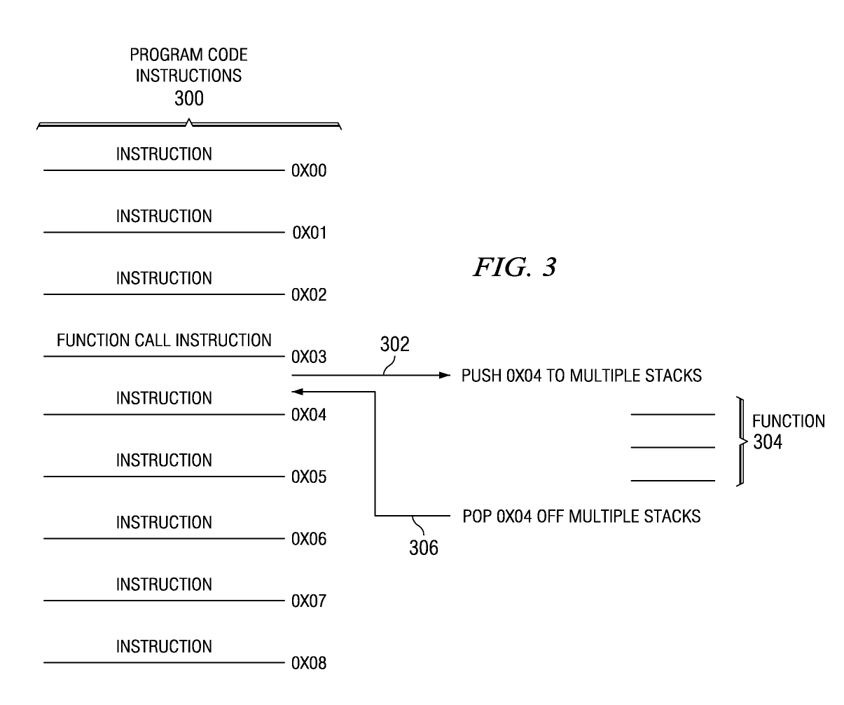

In operation, the processing logic 200 executes the program code 206. The program code 206 may comprise any type of code written using any suitable programming language and for any suitable purpose. Examples comprise spreadsheet programs, word processing programs, financial software, gaming applications, etc. The program code 206 comprises a plurality of instructions which are executed by the processing logic 200. FIG. 3 shows a conceptual illustration of instructions 300 of program code 206. Although a specific number of instructions 300 is shown in FIG. 3, the program code 206 may comprise any number of instructions.

Each of the instructions 300 is associated with (e.g., identified by) a different address. Although address formats may vary from system to system, illustrative addresses are shown adjacent to the instructions 300. The first instruction 300 has an address of 0×00, the second instruction 300 has an address of 0×01, the third instruction 300 has an address of 0×02, and so on. The last instruction 300 shown has an address of 0×08.

The instruction 300 associated with address 0×03 may be a call to a function. A function may be defined as any piece of code (e.g., a subroutine) which is called by a primary body of code and, once executed, returns control flow to the primary body of code. When executed by the processing logic 200, such a call causes the processing logic 200 to store context information associated with the program code 206 and to begin executing the function being called. As indicated by arrow 302, execution flow of the processing logic 200 shifts from the program code 206 to the function 304 due to the function call instruction at address 0×03. The processing logic 200 then proceeds to execute, or service, the function.

As soon as the processing logic 200 begins executing the function (or, in some embodiments, immediately before the processing logic 200 begins executing the function), the processing logic 200 pushes context information (including the return address of 0×04 from, e.g., a program counter) onto the program stack 208. As previously explained, the return address is stored on the program stack 208 so that, when it is finished servicing the function, the processing logic 200 may determine where in the program code 206 to resume execution.

In addition to pushing the context information (e.g., the return address) onto the program stack 208, the processing logic 200 preferably also pushes some or all of the context information onto the protection stack 210. The protection stack 210 preferably comprises a data structure which is separate and distinct from the program stack 208. In preferred embodiments, at least the return address of 0×04 is pushed onto the protection stack 210. Various other context information also may be pushed onto the protection stack 210 as desired. Also, in some embodiments, the context information may be pushed not only onto the program stack 208 and protection stack 210, but also onto one or more additional stacks (not specifically shown), each of which is separate and distinct from the other stacks. Further, in some embodiments, instead of pushing the return address 0×04 onto the stacks, the departure address 0×03 may be pushed onto the stacks and, when control flow returns to the code 300, the address may be incremented to the next available instruction address (i.e., 0×04). In sum, at least a return address or a departure address is pushed onto at least two different stacks.

The processing logic 200 pushes context information onto the program stack 208 because storing the context information in this way is part of executing the function call instruction at address 0×03. However, pushing the context information onto one or more stacks (e.g., the protection stack 210) besides the program stack 208 generally is not part of executing a function call instruction, such as that at address 0×03.

The action of pushing the context information onto at least one other stack may be implemented in any of a variety of ways. In one preferred embodiment, an instruction is embedded at the beginning of the function 304. When executed, this instruction causes the processing logic 200 to read the context information (e.g., the return address) stored on the program stack 208 and to store this information to the push register 212. The processing logic 200 then may push this information from the push register 212 onto the protection stack 210 and/or onto additional stacks. Such an instruction may be:
push_register=_return_address( );
   where _return_address( ) is a function which reads the return address stored on the program stack 208 and push_register corresponds to the push register 212. Other techniques also are possible.

Regardless of the technique used, identical copies of the return address (and, optionally, other context information) are now stored in multiple stacks, including, for example, the program stack 208 and the protection stack 210. The processing logic 200 continues executing function 304. After it finishes executing the function 304, the processing logic 200 pops copies of the return address stored on stacks 208, 210 and any other stack containing the return address. The processing logic 200 then compares these copies of the return address to determine whether they still match. If the copies do not match, then the processing logic 200 determines that a buffer overflow attack has occurred. Specifically, it is likely that a malicious entity has attempted to overwrite one of the copies of the return address stored on one of the stacks (e.g., the program stack 208). In such a case, the processing logic 200 takes appropriate security measures, described below. If the copies do still match, a buffer overflow attack has not occurred. In such a case, the processing logic 200 begins executing the program code 206 at the return address of 0×04, as indicated by arrow 306.

The pop-and-compare technique that is performed after execution of the function 304 may be implemented in any suitable way. For example, in preferred embodiments, an instruction such as
pop_register=_return_address( );
   may cause the logic 200 to pop the return address off of the program stack 208 and to store it in the pop register 214. A similar instruction may be used to pop the return address off of the protection stack 210 (and, optionally, any other stacks storing the return address). The processing logic 200 then may compare the multiple popped values as described above.

As explained, if a mismatch exists between copies of the return address popped off of the multiple stacks, appropriate security measures are taken. For example, the processing logic 200 may generate a security violation signal which is transferred, in some embodiments, to the SSM 202. In turn, the SSM 202 may take one or more actions, including aborting execution of program code and/or resetting part or all of the device 100. In some embodiments, an alert also may be provided to a user of the device 100, such as a visual indication (e.g., an alert message on the display 114, a flashing light-emitting-diode (LED)), an audible indication (e.g., a ring tone or a beeping tone), or a tactile indication (e.g., vibration). In yet other cases, the SSM 202 may cause the logic 200 to abort a current instruction op-code fetch or data retrieval. In still other cases, the SSM 202 may cause the logic 200 from executing malicious code. In some embodiments, a combination of one or more of the above alert signals may be generated by the SSM 202 in response to a received violation signal. The scope of this disclosure is not limited to these possibilities.

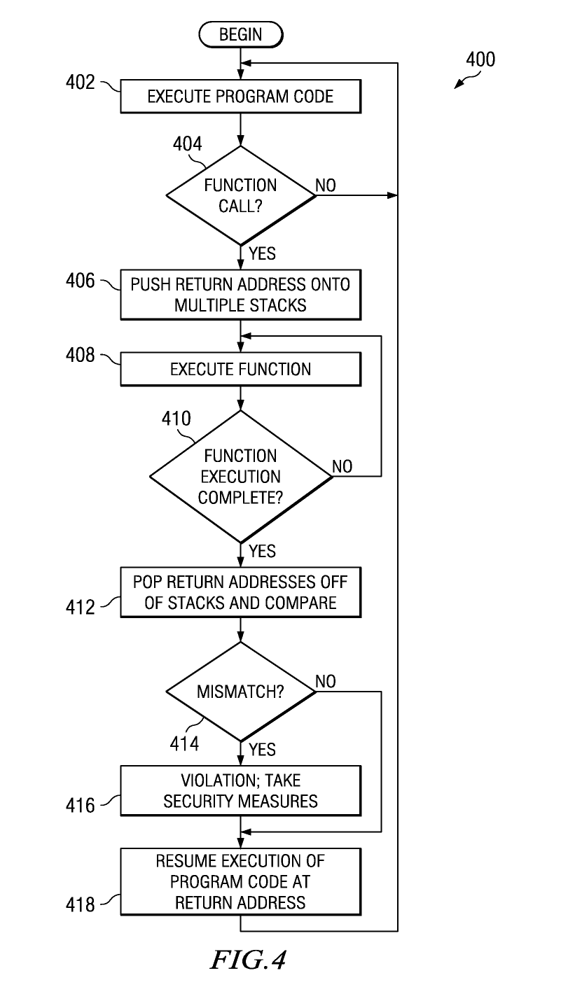

FIG. 4 shows an illustrative flow diagram of a method 400 implemented in accordance with various embodiments. The method 400 begins by executing program code (block 402). The method 400 continues by determining whether a function call instruction has been encountered in the program code (block 404). If not, the method 400 comprises continuing to execute the program code (block 402). However, if a function call instruction is encountered, the method 400 comprises pushing a return address onto multiple stacks (block 406). The method 400 then comprises executing the function (block 408).

The method 400 further comprises determining whether the function execution is complete (block 410). If not, the method 400 comprises continuing to execute the function (block 408). However, if function execution is complete, the method 400 comprises popping copies of the return address off of the various stacks (block 412). The method 400 then comprises comparing the copies to determine whether a mismatch exists (block 414). If so, a security violation signal is generated and sent to the SSM 202, which takes appropriate security measures (block 416). If not, the method 400 comprises resuming execution of the program code at the return address popped off of the stacks (block 418).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
storage comprising software code and a plurality of data structures; and
processing logic coupled to the storage and adapted to execute the software code;
wherein, if the processing logic executes a function call instruction, the processing logic stores copies of software code return information to a first data structure location and to a second data structure location;
wherein if, after executing a function associated with the function call instruction, the processing logic determines that data from the first and second data structure locations and associated with said copies do not match, the processing logic initiates a security measure.

2. The system of claim 1, wherein the system comprises a mobile communication device.

3. The system of claim 1, wherein the processing logic is adapted to initiate the security measure by causing execution of code to be aborted and by resetting at least part of the system.

4. The system of claim 1, wherein the software code return information comprises context information associated with the software code.

5. The system of claim 1, wherein the software code return information comprises a return address associated with the software code.

6. The system of claim 1, wherein the processing logic stores one of said copies to the first data structure and provides the one of said copies from the first data structure to the second data structure using a register.

7. The system of claim 1, wherein the processing logic stores said data from the first data structure to a register and compares said data from the second data structure to contents of said register.

8. A system, comprising:
processing logic adapted to execute software code;
a first data structure location; and
a second data structure location;
wherein, upon returning from a function call to the software code, the processing logic asserts a security signal if values retrieved from the first and second data structure locations do not match, said data structure locations associated with a return address of the software code.

9. The system of claim 8, wherein the first and second data structure locations comprise stack locations, and wherein the processing logic pushes said return address onto said stack locations.

10. The system of claim 8, wherein the system comprises a mobile communication device.

11. A method, comprising:
if, while executing software code, a function call instruction is executed, storing copies of a return address associated with said software code in first and second data structures;
executing a function associated with the function call instruction;
obtaining a first datum from the first data structure and a second datum from the second data structure, the first and second data associated with said copies of the return address; and
if said first and second data do not match, generating a security violation signal.

12. The method of claim 11 further comprising, as a result of the security violation signal, powering down at least part of a mobile communication device housing the first and second data structures.

13. The method of claim 11, wherein the first data does not match any of said copies of the return address.

14. The method of claim 11, wherein storing a copy of said return address to the second data structure comprises storing a copy of the return address to the first data structure and copying contents of the first data structure to the second data structure using a register.

15. The method of claim 11 further comprising storing the first datum to a register and comparing the second datum to contents of said register.

16. A system, comprising:
means for pushing copies of a return address associated with software code onto first and second stacks, said return address associated with a function call instruction in the software code; and
means for initiating security measures;
wherein, after executing a function associated with the function call instruction, the means for pushing determines whether a first datum from the first stack matches a second datum from the second stack, the first and second data associated with said copies;
wherein, if said first and second data are mismatched, the means for pushing alerts the means for initiating security measures.

17. The system of claim 16, wherein the system comprises a mobile communication device.

18. The system of claim 16, wherein the means for initiating security measures initiates a security measure selected from the group consisting of powering down predetermined portions of the system, aborting the execution of malicious code and notifying a user.

19. The system of claim 16, wherein said copies are identical, wherein the first datum matches said copies, and wherein the second datum does not match said copies.

20. The system of claim 16, wherein said means for pushing pushes a copy of the return address onto the second stack by pushing a copy of the return address onto the first stack and transferring the copy of the return address of the first stack to the second stack via a register.

21. The system of claim 16, wherein the means for pushing determines whether the first and second data match by popping said first and second data off of said data structures and comparing said first and second data using a register.
